(19) United States
(12) Patent Application Publication
(10) Pub. No.: US 2024/0028116 A1
(43) Pub. Date: Jan. 25, 2024

(54) TIMER-BASED EYE-TRACKING

(71) Applicant: AdHawk Microsystems Inc., Waterloo (CA)

(72) Inventors: Fan YANG, London (CA); Brendan Redmond O’HANLON, Kitchener (CA); Nino ZAHIROVIC, Waterloo (CA); Niladri SARKAR, Waterloo (CA); Mahdi OLFAT, Kitchener (CA); Mohammad MOHSENZADEH, Waterloo (CA)

(21) Appl. No.: 18/373,921

(22) Filed: Sep. 27, 2023

Related U.S. Application Data
(63) Continuation-in-part of application No. 17/344,046, filed on Jun. 10, 2021, now Pat. No. 11,782,504.
Application No. 17/344,046 is a continuation of application No. 16/234,293, filed on Dec. 27, 2018, now Pat. No. 11,048,327.
(60) Provisional application No. 62/611,477, filed on Dec. 28, 2017.

(51) Int. Cl. G06F 3/01; G01S 17/66; G02B 27/00; G02B 27/01

(52) U.S. Cl. CPC G06F 3/013; G01S 17/66; G02B 27/0093; G02B 27/0172; G02B 26/0833

(57) ABSTRACT

The present disclosure is directed toward eye-tracking by scanning at least one scan beam over a scan region on an eye using a MEMS scanner at a first location, detecting a plurality of glints reflected from the scan region at a plurality of detectors, defining a plane for each glint that includes the location of its respective scanner and its respective detector, and identifying the corneal center of the eye based on the intersection of the plurality of planes. A gaze vector for the eye is then determined based on the corneal center and a pupil center identified using pupillometry.

### CROSS REFERENCE TO RELATED APPLICATIONS

This application is a continuation-in-part of co-pending U.S. patent application Ser. No. 17/344,046, filed Jun. 10, 2021 (Attorney Docket: 3146-001US2), which is a continuation of U.S. patent application Ser. No. 16/234,293 (now U.S. Pat. No. 11,048,327), filed Dec. 27, 2018 (Attorney Docket: 3146-001US1), which claims the benefit of U.S. Provisional Patent Application Ser. No. 62/611,477 filed 28 Dec. 2017, each of which is incorporated by reference as if set forth at length herein. In addition, this application includes concepts disclosed in United States Patent Application Ser. Nos. 63/391,059, filed Jul. 21, 2022 (Attorney Docket: 3146-016PR1) and Ser. No. 18/225,008, filed Jul. 21, 2023 (Attorney Docket: 3146-016US1), as well as United States Patent Publication Nos. 2016/0166146 published 16 Jun. 2016 (Attorney Docket: 3001-004US1) and 2017/0276934 published 28 Sep. 2017 (Attorney Docket: 3001-004US2), each of which is incorporated by reference as if set forth at length herein.

### TECHNICAL FIELD

This disclosure relates generally to human—computer interfaces and more specifically to eye-tracking systems, methods and structures that advantageously provide real-time measurements of eye-tracking and eye fixations.

### BACKGROUND

As is known by those skilled in the art, human—computer interfaces are expected to take advantage of visual input mechanisms including eye-tracking mechanisms—resulting from a current trend in the emerging Virtual and Augmented Reality (VR/AR) enterprise.

Of additional note, such eye-tracking mechanisms are expected to find widespread applicability in medical ophthalmology, behavioral psychology, and consumer measurement fields as well.

Given such applicability and importance, improved eye-tracking systems, methods and/or structures would represent a welcome addition to the art.

### SUMMARY

The present disclosure enables eye tracking without some of the costs and disadvantages of eye-tracking systems of the prior art. An advance in the art is made according to aspects of the present disclosure directed to systems, methods, and structures providing timer-based eye-tracking that advantageously facilitate a seamless, intuitive, non-invasive, interactive user interface between that user and smart devices including computers.

In addition to such human-computer interactions, timer-based eye-tracking systems, methods and structures according to aspects of the present disclosure advantageously facilitate the development of ophthalmological measurement instruments for determining geometric and/or other eye features exhibiting a precision and reproducibility unknown in the art. Such determinations advantageously include shape(s), geometry(ies), of eye feature(s) including the cornea, iris, sclera, etc., as well as their respective interfaces.

In a broad context, systems, methods, and structures disclosed in the parent applications (i.e., U.S. patent application Ser. Nos. 17/344,046 and 16/234,293) provide eye-tracking by 1) steering a beam of light, through the effect of a microelectromechanical system (MEMS) scanner, onto eye structures, such as corneal surface, iris, and/or sclera; 2) detecting—by one or more discrete detectors (i.e., 4, 6, 8, etc.)—light reflected from the eye; and 3) tracking the timings at which reflections from the eye are detected.

A glint arising from specular reflection of the beam of light off the eye may be detected as a large-amplitude, narrow-width pulse, whereas a tracked pupil will produce an absence of reflected light in a region of a scanned pattern. In some embodiments, one or more discrete detectors may be selected to use a negative threshold for pupil tracking and/or a positive threshold for glint tracking thereby—and advantageously—enabling the discrimination between, and identification of, glint features and pupil features.

The present disclosure extends the teachings of the parent applications by virtue of the recognition that a plane in three-dimensional space can be defined by: 1) the locations of the scanner and detector in three-dimensional space; and 2) a scanner-to-glint vector that is based on the time that the glint is detected by the detector. By employing three different operatively coupled scanner/detector sets, three such planes can be defined. The point of intersection of these three planes in three-dimensional space corresponds to the center of curvature of the cornea of the eye (i.e., the corneal center).

An illustrative embodiment is a system comprising a processor, first and second transmit modules, and first and second detect modules, each of which is mounted on eyeglass frames. The first and second transmit modules are located at first and second locations, respectively, and the first and second detect modules that are located at third and fourth locations, respectively. Each of the transmit modules includes a MEMS-based scanner that is configured to steer a light signal in a two-dimensional pattern about a scan region on an eye. Specular reflection of the first light signal off the cornea at a first position gives rise to a first glint that is received at the first detect module at a first time. Specular reflection of the first light signal off the cornea at a second position gives rise to a second glint that is received at the second detect module at a second time. In similar fashion, the MEMS scanner of the second transmit module is configured to steer a second light signal in a two-dimensional pattern about the scan region. Specular reflection of the second light signal off the cornea at a third position gives rise to a third glint that is received at the second detect module at a third time.

The processor is configured to determine: 1) a first plane in three-dimensional space based upon the first and third locations and a first scanner-to-glint vector based on the first time 2) a second plane in three-dimensional space based upon the first and fourth locations and a second scanner-to-glint vector based on the second time; 3) a third plane in three-dimensional space based upon the second and fourth locations and a third scanner-to-glint vector based on the third time; 4) the corneal center of the eye as defined by the point in three-dimensional space at which the three planes intersect; 5) the center of the pupil of the eye based on an output signal from one of the first and second detect modules; and 6) a gaze vector for the eye based on the corneal center and the center of the pupil.

In some embodiments, the first and second light signals are phase modulated with respect to one another to enable the first and second detect modules to discriminate the transmit module with which the first and second glints are associated. In some such embodiments, the first and second light signals are modulated such that they are 180° out of phase with each other.

In some embodiments, the first and second light signals are time multiplexed such that only one is directed toward the scan region at any one time.

In some embodiments, only one transmit module is used and its location is common to each of the first and second planes. In such embodiments, only two planes are defined, with the location of the transmit module being common to both. The two planes intersect at a line that extends through the corneal center, the location of which on that line is determined by, for example, conventional numerical methods.

An embodiment in accordance with the present disclosure is a system for timer-based eye-tracking, the system comprising: a first microelectromechanical system (MEMS) scanner for steering a first scan beam in a first two-dimensional pattern over a scan region of an eye, the first MEMS scanner being located at a first location; a first detector configured to detect a first glint from a first reflection point in the scan region at a first time, the first glint including a first portion of the first scan beam, wherein the first detector is a discrete detector and is located at a second location; and a processor configured to (1) determine a first orientation of the first MEMS scanner at the first time.

Another embodiment in accordance with the present disclosure is a system for timer-based eye-tracking, the system comprising: a first microelectromechanical system (MEMS) scanner for steering a first scan beam in a first two-dimensional pattern over a scan region of an eye, the first MEMS scanner being located at a first location; a first detector that is located at a second location, the first detector being a discrete detector; a second detector that is located at a third location, the second detector being a discrete detector; a second MEMS scanner for steering a second scan beam in a second two-dimensional pattern over the scan region, the second MEMS scanner being located at a fourth location; and a processor; wherein the first detector is configured to detect a first glint from a first reflection point in the scan region at a first time and a second glint from a second reflection point in the scan region at a second time, the first glint including a first portion of the first scan beam, and the second glint including a first portion of the second scan beam; wherein the second detector is configured to detect a third glint from a third reflection point in the scan region at a third time, the third glint including a second portion of the first scan beam; and wherein the processor is configured to: (1) define a first plane based on a first orientation of the first MEMS scanner at the first time, the first location, and the second location; and (2) define a second plane based on a second orientation of the second MEMS scanner at the second time, the second location, and the fourth location.

Yet another embodiment in accordance with the present disclosure is a method for eye tracking, the method comprising: steering a first scan beam through the effect of a first microelectromechanical system (MEMS) scanner through a first two-dimensional pattern over a scan region on an eye, the first MEMS scanner being located at a first location; detecting a first glint from a first reflection point in the scan region at a first time at a first detector, wherein the first glint includes a first portion of the first scan beam, and wherein the first detector is a discrete detector and is located at a second location; and determining a first orientation of the first MEMS scanner at the first time.

### BRIEF DESCRIPTION OF THE DRAWINGS

FIGS. 1A-B depict schematic drawings of a perspective view and illustrative geometric arrangement, respectively, of an eye-tracking system in accordance with the present disclosure.

FIG. 2 depicts operations of a method for determining a gaze vector for an eye in accordance with the present disclosure.

FIG. 3A depicts a schematic diagram of the relationship between a pair of glint planes of system 100.

FIG. 3B depicts a schematic diagram of the relationship between a different pair of glint planes of system 100.

FIG. 4 depicts a schematic diagram of the combined relationships between all three glint planes of shown in FIGS. 3A-B.

The illustrative embodiments are described more fully by the Figures and detailed description. Embodiments according to this disclosure may, however, be embodied in various forms and are not limited to specific or illustrative embodiments described in the drawing and detailed description.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The functions of the various elements shown in the Drawing, including any functional blocks that may be labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the figures comprising the drawing are not drawn to scale.

As will become apparent to those skilled in the art, systems, methods, and structures according to aspects of the present disclosure advantageously extend the capabilities of gesture tracking systems disclosed in the parent applications, U.S. Patent Publication Nos. US2016/0166146 (hereinafter referred to as the '146 publication) and US2021/0303064 (hereinafter referred to as the '064 publication), each of which disclosed scanning microelectromechanical systems that determine the position of an eye by directing a beam of light towards the eye and determining the unique angle at which the beam reflects off the cornea of the eye to determine the direction of the gaze of the user. Systems in accordance with the present disclosure and the '146 and '064 publications enable eye tracking that can be faster, lower power, more precise, and lower cost than prior-art video-based systems.

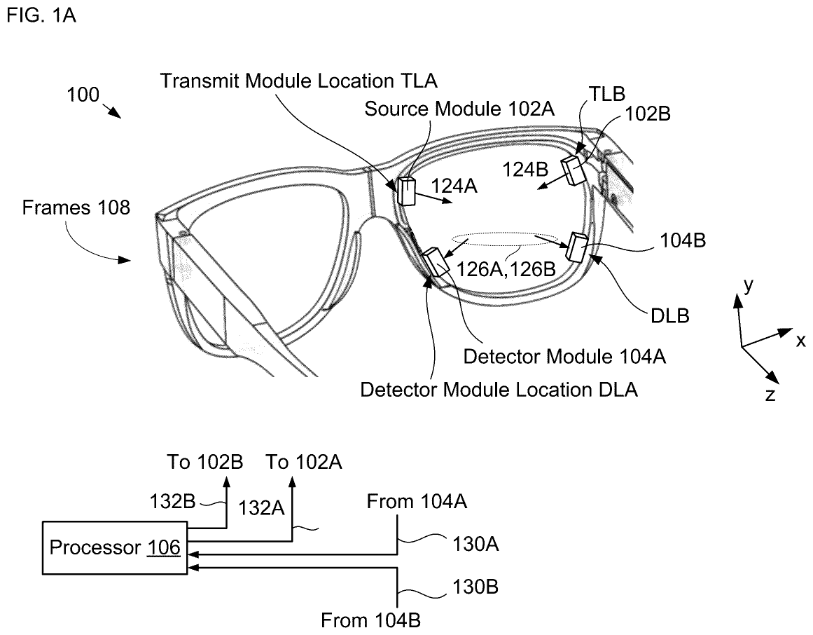

FIGS. 1A-B depict schematic drawings of a perspective view and illustrative geometric arrangement, respectively, of an eye-tracking system in accordance with the present disclosure. System 100 includes transmit modules 102A and 102B, detect modules 104A and 104B, and processor 106. In the depicted, illustrative example, system 100 is mounted on eyeglass frames 108 such that, when the frames are worn by a test subject, the system is operative for tracking eye 110 of the test subject.

Each of transmit modules 102A and 102B comprises light source 112 and scanner 114, which collectively provide an optical signal and steer it in a two-dimension pattern over scan region 116 on eye 110. In the depicted example, scan region 116 includes a portion of the sclera of the eye, as well as cornea 118, iris 120, and pupil 122.

Transmit module 102A provides scan beam 124A as a first light beam directed at the scan region, while transmit module 102B provides scan beam 124B as a second light beam directed at the scan region. Exemplary transmit modules are described in detail in the '146 and '064 publications; however, it should be noted that transmit modules in accordance with the present invention are not limited to those disclosed in these publications.

Each of detect modules 104A and 104B is a sub-system configured to receive portions of scan beams 124A and 124B reflected from scan region 116 as reflected signals 126A and 126B. Each of detect modules 104A and 104B includes discrete detector 128 for providing an electrical signal (i.e., output signals 130A and 130B) based on the intensity of the reflected light, and detecting—among other possible things—one or more maxima and/or minima in the electrical signals. For the purposes of this disclosure, including the appended claims, a “discrete detector” is defined as an optoelectronic device having no more than four electrically independent detection regions on a single substrate, where each detection region is operative for providing one electrical signal whose magnitude is based on the intensity of light incident upon that detection region. Examples of discrete detectors include detectors having only one detection region, split detectors having two detection regions, four-quadrant detectors having four detection regions, and position-sensitive detectors. The definition of discrete detector explicitly excludes individual pixels, or groups of pixels, within array devices for collectively providing spatially correlated image information, such as focal-plane arrays, image sensors, and the like. Exemplary detect modules are described in detail in the '146 and '064 publications; however, it should be noted that transmit modules in accordance with the present invention are not limited to those disclosed in these publications.

Processor 106 is a conventional digital processor and controller (e.g., a microcontroller, microcomputer, etc.) operative for controlling transmit modules 102A and 102B, establishing system timing, and estimating the two-dimensional location of the cornea of the eye (for example) within the scan region. In the depicted example, processor 106 communicates with transmit modules 102A and 102B and detect modules 104A and 104B via wired connections (not shown) to transmit control signals 132A and 132B to transmit modules 102A and 102B, respectively, and receive output signals 130A and 130B from detect modules 104A and 104B, respectively. In some embodiments, processor 106 communicates with the transmit modules and detect modules wirelessly. In some further embodiments, processor 106 is at least partially integrated in one of the transmit modules and/or detect modules. Note further that in those embodiments including multiple detector modules there may be multiple output signals communicating with the processor. Note further that in those configurations including multiple detectors included as part of a single detector module, the multiple detectors may provide individual, multiple signal lines to the processor as well or may be locally processed by detector module thereby providing a single signal to the processor.

The operation of system 100 is founded on eye tracking methods described in detail in the '146 and '064 publications, which are enabled by 1) steering a beam of light through a two-dimensional pattern over a scan region that includes eye structures such as corneal surface, iris, and/or sclera; and 2) detecting light reflected from the corneal surface at one or more discrete detectors. By tracking the orientation of the scanner that directs the beam of light towards the eye and determining the scanner orientation at which the beam reflects off the cornea of the eye, and the timing of the detection of the reflection, the direction of the gaze of the user can be determined.

A glint may be detected as large amplitude pulses of narrow width. In contrast, a tracked pupil will produce an absence of reflected light in a portion of a scanned pattern. Advantageously, one or more discrete detectors may be selected to use a negative threshold for pupil tracking and/or a positive threshold for glint tracking thereby. As a result, systems in accordance with the present disclosure enable discrimination between glint features and pupil features of an eye, as well as the identification of their locations in three-dimensional space.

Furthermore, since all required relevant information is included in timing information received from the one or more discrete detectors and any timing of produced pulses, a Lissajous scan pattern can be employed to advantageously produce a superior pulse density over a projected region of the eye. Of further advantage, when a sufficient number of pulses is detected/collected by the multiple detectors, a contour of the glint and location(s) of eye features, such as the cornea, corneal center, pupil, and the like, can be determined.

System 100 is shown mounted on frames 108 such that transmit modules 102A and 102B and detect modules 104A and 104B are in a fixed location and orientation relative to the frames. Specifically, transmit modules 102A and 102B is mounted on the frames such that their respective scanners are located at transmit module locations TLA and TLB, which enable each transmit module to steer its respective scan beam over the full extent of a desired scan region on the eye. Detect modules 104A and 104B are mounted on the frames such that their respective detectors are located at detect module locations DLA and DLB, respectively, which enables the detectors of each detect module to receive reflections of both scan beams from the scan region. In some embodiments, one of the detect modules is mounted such that its detector can receive reflections of only one of the scan beams.

Those skilled in the art will appreciate that the respective positions of transmit module(s) and detect module(s) can be different from those illustratively shown including spaced-apart relative to one another and/or arranged in a pre-determined or no particular arrangement around—for example—eyeglass frames or goggles or shield or other mechanical support. Furthermore, the specific location(s) of the one or more transmit module(s) and/or detect modules including one or more individual discrete detectors may be adjustable on the frame structures such that systems, method, and structures according to the present disclosure may advantageously provide enhanced informational value for a larger portion of the population. Still further, transmit modules 102A and 102B can be combined in a single module and/or detect modules 104A and 104B can be combined in a single module.

System 100 enables tracking of a surface feature of the eye (e.g., cornea or other feature including pupil, iris, sclera, eyelid, etc.) during typical test-subject behavior (e.g., reading, viewing a computer screen, watching television, monitoring a scene, shopping, other consumer activities, responding to stimulus, etc.), and estimating and/or determining the gaze vector of the eye based on the location of the surface feature (and perhaps other characteristics).

For the purposes of this Specification, including the appended claims, the “gaze vector” of an eye is defined as the gaze direction of the eye. As may be readily appreciated by those skilled in the art, we note that the optical axis of an eye is not the same as a visual axis. More specifically, the optical axis may be substantially aligned—for illustrative example—with an optical centerline of the eye while the visual axis is more substantially aligned with a visual acuity location of the eye, namely the fovea centralis. The fovea is responsible for sharp central vision, which is necessary in humans for activities where visual detail is of primary importance, such as reading and driving. Accordingly, a gaze vector is preferably indicated by a vector extending outward along the visual axis. As used herein and as will be readily understood by those skilled in the art, “gaze” suggests looking at something—especially that which produces admiration, curiosity or interest—among other possibilities.

Transmit modules 102A and 102B and detector modules 104A and 104B are configured such that the collectively establish four operatively coupled scanner/detector sets:
SD-1, including transmit module 102A and detect module 104A;
SD-2, including transmit module 1028 and detect module 1048;
SD-3, including transmit module 1028 and detect module 104A; and
SD-4, including transmit module 102A and detect module 1048.

For ease of discussion, the exemplary transmit and detect modules in the geometric arrangement depicted in FIG. 1B are designated simply as transmit module 102 and detect module 104; however, the depicted example is representative of any of the four operatively coupled scanner/detector sets defined above. Further, for clarity and convenience, the arrangement depicted in FIG. 1B shows transmit module 102 and detect module 104 on opposite sides of optical axis A1 of eye 110. As indicated in FIG. 1, however, some scanner/detector sets include transmit and detect modules that are on the same side of optical axis A1.

Transmit module 102 includes optical source 112 for providing scan beam 124 and scanner 114 for steering scan beam 124 over scan region 116 in two dimensions by rotating a scanning element (e.g., a mirror) about orthogonal axes designated as the θ-axis and the ϕ-axis. The rotation angles, θ and ϕ, of the scanning element about the θ-and ϕ-axes defines the orientation of a scanner. Scanners suitable for use in accordance with the present disclosure, as well as methods for forming them, are described in the parent applications, as well as U.S. Patent Publication 20150047078, entitled “Scanning Probe Microscope Comprising an Isothermal Actuator,” published Feb. 12, 2015, and U.S. Patent Publication 20070001248, entitled “MEMS Device Having Compact Actuator,” published Jan. 4, 2007, each of which is incorporated herein by reference.

In response to control signal 132 from processor 106, scanner 114 steers scan beam 124 in a two-dimensional pattern over scan region 116. In the depicted example, scan beam 124 is steered through a Lissajous curve—also known as a Lissajous figure—which is the graph of a system of parametric equations defined by x=A sin(at+δ); γ=B sin(bt). The instantaneous propagation direction of scan beam 124 at time t depends upon the instantaneous orientation of scanner 114.

It should be noted that scan patterns other than a Lissajous curve (e.g., raster patterns, Rosette patterns, etc.) can be used without departing from the scope of the present disclosure.

As scan beam 124 is scanned over scan region 116 some of its light is reflected toward detector 128 as reflected signal 126.

As will be appreciated by one skilled in the art, after reading this Specification, for each scanner/detector set SD-i, where i=1 through 4, there exists a particular orientation of scanner 114 that directs scan beam 124 at a unique point on cornea 118 that gives rise to specular reflection toward its respective detect module 104. As scan beam 124 is scanned through this point, the specular reflection is received by detector 128 as a short flash of relatively high-intensity light (i.e., glint G-i) at a time, t_{g}-i.

The orientation of the scanner 114 of scanner/detector set SD-i at time t_{g}-i is based on control signal 132 from processor 106; therefore, it can be readily determined, thereby defining a unique source-to-glint vector SGV-i for that scanner/detector set.

It is an aspect of the present disclosure that, for each scanner/detector set, a unique plane in three-dimensional space is defined by the location of its scanner, the location of its detector, and its source-to-glint vector. Furthermore, these planes can be used to identify the position, in three-dimensional space of the corneal center of the cornea of an eye. Still further, as discussed in the parent applications, eye tracking systems in accordance with the present disclosure can be used to perform pupillometry to identify the center of the pupil, thereby enabling identification of the gaze vector of the eye as the line extending from the corneal center to the center of its pupil.

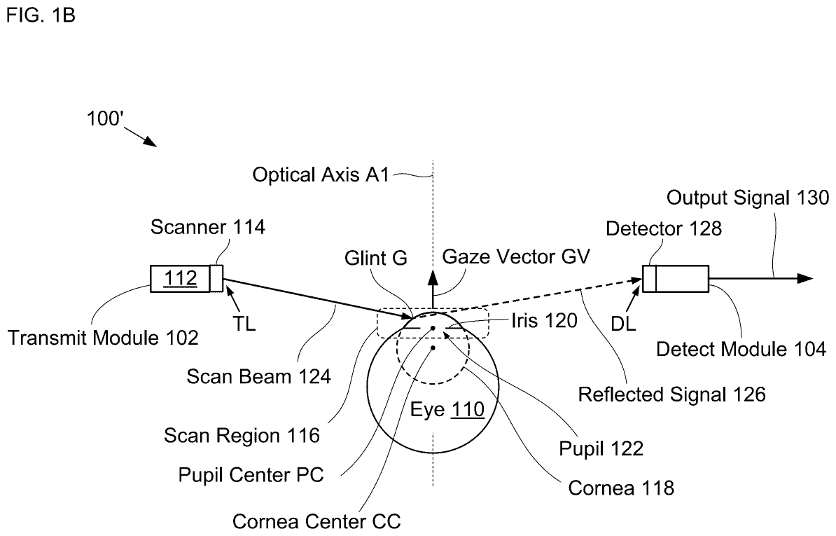

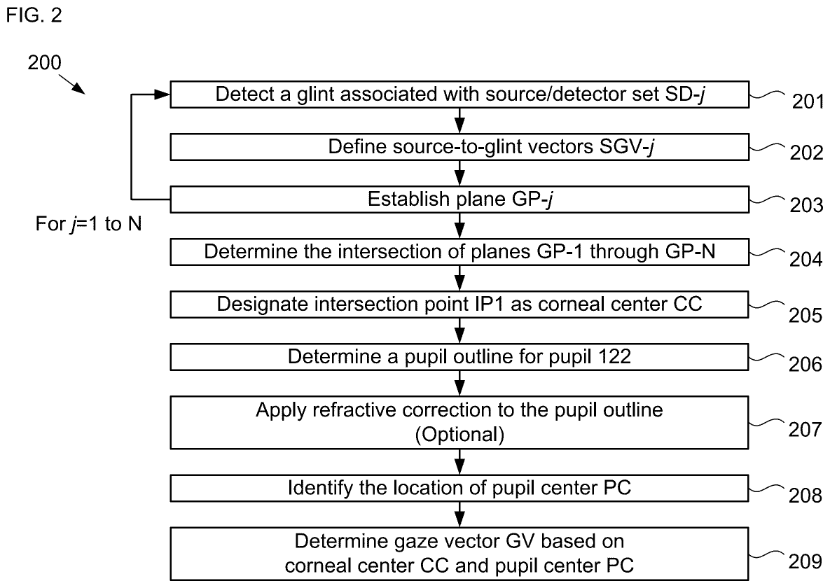

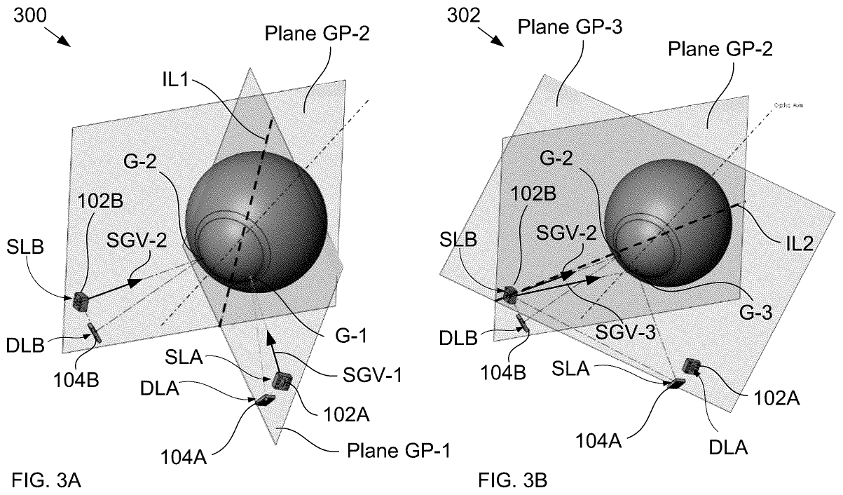

FIG. 2 depicts operations of a method for determining a gaze vector for an eye in accordance with the present disclosure. Method 300 is described with continuing reference to FIG. 1, as well as reference to FIGS. 3A-B and 4.

Method 200 begins with operation 201, wherein, for j=1 through N, glint G-j is detected at time tⱼ for scanner/detector set SD-j. In the depicted example, N=3; however, in some embodiments, N is greater than 3 as discussed below.

It should be noted that, in practice, each of glints G-j can include a locus of points in three-dimensional space, all of which satisfy the reflection laws for specular reflection. As a result, in some embodiments, the center of each locus of points is identified by: 1) identifying a contour of a glint region containing a plurality of contour points for which reflection from the cornea exceeds a threshold (e.g., by employing pulse-width tracking, leading-edge tracking, etc.); 2) employing one or more fitting functions on a sparse set of the contour points (for example, all of the points gathered in a particular period of time (e.g., 10 milliseconds)) to fit an ellipse which advantageously provides a low-latency measurement of glint location; and 3) identifying the center of the ellipse and designating it as the location of the glint. More detailed discussions of some exemplary approaches suitable for performing ellipse fitting on one or more glints detected in a scan region is found in the parent applications.

At operation 202, for j=1 through N, the orientation at time tⱼ of scanner 114 of scanner/detector set SD-j is determined, thereby defining source-to-glint vector SGV-j.

At operation 203, for j=1 through N, glint plane GP-j is established for scanner/detector set SD-j based on locations SL and DL, respectively, of its respective scanner 114 and detector 128.

FIG. 3A depicts a schematic diagram of the relationship between a pair of glint planes of system 100.

Plot 300 shows glint planes GP-1 and GP-2, which intersect along intersection line ILL

Glint plane GP-1 is defined by scanner/detector set SD-1 and glint G1—specifically, location TLA of scanner 114 within transmit module 102A, location DLA of detector 128 within detect module 104A, and source-to-glint vector SGV-1.

Glint plane GP-2 is defined by scanner/detector set SD-2 and glint G2—specifically, location TLB of scanner 114 within transmit module 102B, location DLB of detector 128 within detect module 104B, and source-to-glint vector SGV-2.

FIG. 3B depicts a schematic diagram of the relationship between a different pair of glint planes of system 100.

Plot 302 shows glint planes GP-2 and GP-3, which intersect along intersection line IL2.

Glint plane GP-3 is defined by scanner/detector set SD-3 and glint G3—specifically, location TLB of scanner 114 within transmit module 102B, location DLB of detector 128 within detect module 104A, and source-to-glint vector SGV-3.

At operation 204, the point in three-dimensional space at which glint planes GP-1 through GP-N intersect (i.e., intersection point IP1) is determined.

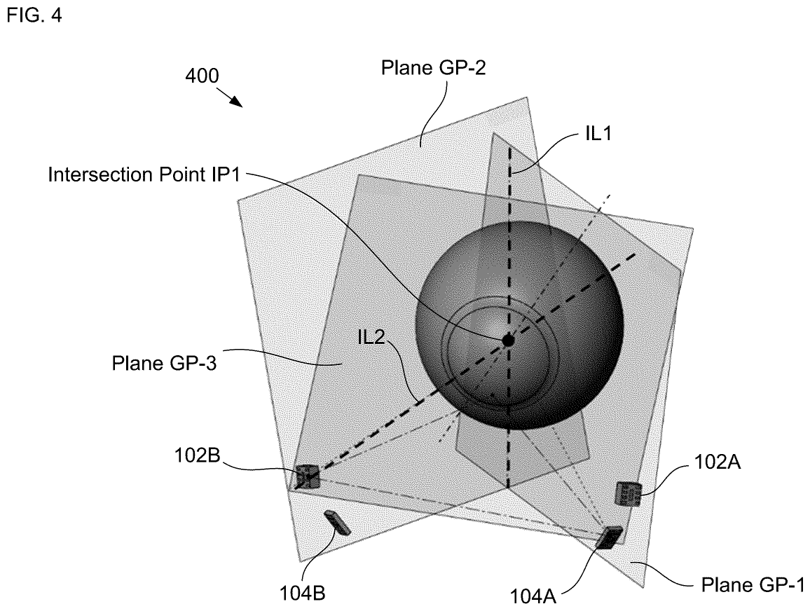

FIG. 4 depicts a schematic diagram of the combined relationships between all three glint planes shown in FIGS. 3A-B.

As is evinced by plot 400, intersection lines IL1 and IL2 cross at a single point in three-dimensional space—intersection point IP1.

At operation 205, intersection point IP1 is designated as corneal center CC of cornea 118.

As noted above, in some embodiments more than three glints and planes are used to determine corneal center CC (i.e., N>3), which provides redundancy (e.g., enabling recovery from an occlusion by the eyelids, sclera, etc.), the ability to reject one or more glints as outliners, provide an overconstrained system that can be solved using, for example, a least squares method, and the like.

At operation 206, an outline of pupil 122 is estimated. In the depicted example, the pupil outline is identified using ellipse fitting; however, any suitable method for determining a pupil outline for eye 110 can be used without departing from the scope of the present disclosure.

As mentioned briefly above, systems, methods, and structures according to aspects of the present disclosure may advantageously detect reflections resulting from eye features/structures other than cornea 118 (e.g., edge-of-pupil reflections, sclera reflections, etc.).

Operationally, systems, methods, and structures according to aspects of the present disclosure perform pupillometry by setting a threshold at a predetermined point such that edges of structures are detected and then determine the outline of the pupil from the timings of threshold crossing in any (arbitrary) directions.

One illustrative approach for pupillometry according to aspects of the present disclosure includes:
1. Measuring signal levels corresponding to specular glints from the cornea, diffuse reflections from the iris, and lower signal levels (lack of iris reflection) from the pupil;
2. Setting a threshold voltage for a comparator between the low-level signal from the pupil and the diffuse reflection signal level from the iris;
3. Capturing pulses in reflected signal 126 that correspond to the pupil edge transitions for a period of time and perform fitting routines, such as the ellipse-fitting technique described above; and
4. Applying correction factors to compensate for the refractive index of the cornea/lens and the direction in which the eye is pointing in order to reveal the pupil size; and
5. identifying the location of the outline of pupil 122.

At this point we note that when attempting pupillometry, the signals are not necessarily low as they are determined by the contrast from pupil to iris. The contrast is actually quite high—although orders of magnitude less than for a glint. One significant problem with pupillometry is that of non-uniform illumination/sensitivity across a scan range. In other words, pupillometry is negatively impacted by the non-uniform illumination wherein the path length between scanner and detector varies across the scan range as reflected from the features of the eye. An increased path length drops the detected signal and therefore creates gradients that makes fixed threshold pupil detection difficult. Advantageously, and according to still further aspects of the present disclosure, one way to overcome this infirmity is to sum the signals from multiple detectors such that the average path length of the beam(s) is roughly equal as compared with any signal drop magnitude created by the pupil. Such summing may also be performed in a weighted matter such that the signal is “leveled” against the background. This calibration may occur—for example—when a user has their eyes closed so as to optimize a uniform diffuse reflection signal in the absence of the pupil thus making pupil detection easier.

It should be further noted that systems, methods, and structures may advantageously adjust laser power dynamically to compensate for non-uniform illumination. In addition, the gain(s) or threshold(s) may be dynamically adjusted to mitigate the non-uniform illumination as well.

Unfortunately, in some cases, reflections from the iris plane and pupil edge are subject to corneal refraction that occurs at the surface of the cornea, which can result in a slight difference between the perceived location of the pupil and its true location in three-dimensional space.

In some embodiments, therefore, at optional operation 207, in some embodiments, refractive correction is applied to the pupil outline.

In some embodiments, refractive correction includes the use of a corneal position and cornea model determined through the use of the specular reflection from the surface of the cornea.

In some embodiments, refractive correction includes the use of a-priori knowledge (or estimation) of the refractive index of the corneal tissue at one or more locations in the scan region is used in some embodiments to improve the accuracy of the determination of the three-dimensional location.

In some embodiments, refractive correction employs suitable eye models based on glint reflections as embodied by reference material in the literature.

In some embodiments, refractive correction employs a subsystem of a prior-art camera-based eye tracker, a Lissajous scanning eye tracker employing source module 104, or a combination thereof.

In some embodiments, a calibration step is employed in which processor 106 estimates an index of refraction and effective corneal radius through numerical means, such as regression, machine learning, and the like by collecting eye-specific data per user by employing a per user calibration. A per user calibration may be performed by presenting a plurality of calibration gaze targets optionally characterized by known ground truth locations. The calibration gaze targets may be presented to the user as physical markers located relative to a headset frame by a headset mounted camera, through a head-mounted display or other such means.

At operation 208, pupil center PC of eye 110 is determined based on the pupil outline.

At operation 209, the gaze vector GV for eye 110 is determined based on corneal center CC and pupil center PC.

Although the depicted example employs two transmit modules and two detect modules, in some embodiments, only one transmit module is used with three or more detect modules. Such embodiments afford some advantages over the prior art, such as overall system cost, power savings, etc.

However, as will be apparent to one skilled in the art, such configurations require additional computation because both the scanner location and the corneal center are in all three planes; therefore, one of the planes is redundant. In such embodiments, it is necessary to estimate the corneal center along a line of intersection of two planes using conventional numerical methods.

It is to be understood that the disclosure teaches just some examples of illustrative embodiments and that many variations of the invention can easily be devised by those skilled in the art after reading this disclosure and that the scope of the present invention is to be determined by the following claims.

What is claimed is:

1. A system for timer-based eye-tracking, the system comprising:
a first microelectromechanical system (MEMS) scanner for steering a first scan beam in a first two-dimensional pattern over a scan region of an eye, the first MEMS scanner being located at a first location;
a first detector configured to detect a first glint from a first reflection point in the scan region at a first time, the first glint including a first portion of the first scan beam, wherein the first detector is a discrete detector and is located at a second location; and
a processor configured to (1) determine a first orientation of the first MEMS scanner at the first time.

2. The system of claim 1 wherein the processor is further configured to:
(2) establish a first scanner-to-glint vector based on the first orientation; and
(3) define a first plane that includes the first location, the second location, and the first scanner-to-glint vector.

3. The system of claim 1 further comprising:
a second detector configured to detect a second glint from a second reflection point in the scan region at a second time, the second glint including a second portion of the first scan beam, wherein the second detector is a discrete detector and is located at a third location;
wherein the processor is further configured to (2) determine a second orientation of the first MEMS scanner at the second time.

4. The system of claim 3 wherein the processor is further configured to:
(3) define a first plane that includes the first location, the second location, and a first scanner-to-glint vector that is based on the first orientation;
(4) define a second plane that includes the first location, the third location, and a second scanner-to-glint vector that is based on the second orientation; and
(5) identify a first line of intersection between the first and second planes.

5. The system of claim 4 wherein the processor is further configured to:
(6) identify a corneal center for a cornea of the eye based on the first line of intersection.

6. The system of claim 4 further comprising:
a second MEMS scanner for steering a second scan beam in a second two-dimensional pattern over the scan region, the second MEMS scanner being located at a fourth location;
wherein the first detector is further configured to detect a third glint from a third reflection point in the scan region at a third time, the third glint including a first portion of the second scan beam; and
wherein the processor is further configured to:
(6) determine a third orientation of the second MEMS scanner at the third time;
(7) define a third plane that includes the fourth location, the second location, and a third scanner-to-glint vector that is based on the third orientation; and
(8) identify a corneal center for a cornea of the eye based on an intersection point of the first, second, and third planes.

7. The system of claim 6 wherein the first detector is further configured to provide a first output signal based on a reflection signal from the scan region that includes at least one of (a) a third portion of the first scan beam reflected from the scan region and (b) a second portion of the second scan beam reflected from the scan region, and wherein the processor is further configured to:
(10) identify a pupil center for the eye based on the first output signal; and
(11) define a gaze vector for the eye based on the corneal center and the pupil center.

8. The system of claim 6 wherein the first and second scan beams are out of phase with each other.

9. The system of claim 6 further comprising:
a first source for providing the first scan beam; and
a second source for providing the second scan beam;
wherein, when one of the first and second sources is on, the other of the first and second sources is off.

10. A system for timer-based eye-tracking, the system comprising:
a first microelectromechanical system (MEMS) scanner for steering a first scan beam in a first two-dimensional pattern over a scan region of an eye, the first MEMS scanner being located at a first location;
a first detector that is located at a second location, the first detector being a discrete detector;
a second detector that is located at a third location, the second detector being a discrete detector;
a second MEMS scanner for steering a second scan beam in a second two-dimensional pattern over the scan region, the second MEMS scanner being located at a fourth location; and
a processor;
wherein the first detector is configured to detect a first glint from a first reflection point in the scan region at a first time and a second glint from a second reflection point in the scan region at a second time, the first glint including a first portion of the first scan beam, and the second glint including a first portion of the second scan beam;
wherein the second detector is configured to detect a third glint from a third reflection point in the scan region at a third time, the third glint including a second portion of the first scan beam; and
wherein the processor is configured to:
(1) define a first plane based on a first orientation of the first MEMS scanner at the first time, the first location, and the second location; and
(2) define a second plane based on a second orientation of the second MEMS scanner at the second time, the second location, and the fourth location.

11. The system of claim 10 wherein the processor is further configured to (3) identify a corneal center of the eye based on an intersection of the first and second planes.

12. The system of claim 10 wherein the processor is further configured to:
(3) define a third plane based on a third orientation of the first MEMS scanner at the third time, the first location, and the third location; and
(4) identify the corneal center based on an intersection of the first, second, and third planes.

13. The system of claim 12 wherein one of the first and second detectors is configured to provide an output signal based on a first reflection signal from the scan region, the first reflection signal including at least one of a third portion of the first scan beam and a second portion of the second scan beam, and wherein the processor is further configured to:
(5) identify a pupil center of the eye based on the first reflection signal; and
(6) define a gaze vector for the eye based on the corneal center and the pupil center.

14. The system of claim 10 wherein the first and second scan beams are out of phase with each other.

15. The system of claim 10 further comprising:
a first source for providing the first scan beam; and
a second source for providing the second scan beam;
wherein, when one of the first and second sources is on, the other of the first and second sources is off.

16. A method for eye tracking, the method comprising:
steering a first scan beam through the effect of a first microelectromechanical system (MEMS) scanner through a first two-dimensional pattern over a scan region on an eye, the first MEMS scanner being located at a first location;
detecting a first glint from a first reflection point in the scan region at a first time at a first detector, wherein the first glint includes a first portion of the first scan beam, and wherein the first detector is a discrete detector and is located at a second location; and
determining a first orientation of the first MEMS scanner at the first time.

17. The method of claim 16 further comprising:
detecting a second glint from a second reflection point in the scan region at a second time at a second detector, wherein the second glint includes a second portion of the first scan beam, and wherein the second detector is a discrete detector and is located at a third location;
determining a second orientation of the first MEMS scanner at the second time;
defining a first plane that includes the first location, the second location, and a first scanner-to-glint vector based on the first orientation;
defining a second plane that includes the first location, the third location, and a second scanner-to-glint vector based on the second orientation; and
identifying a corneal center for the eye based on the first and second planes.

18. The method of claim 17 further comprising:
steering a second scan beam through the effect of a second MEMS scanner through a second two-dimensional pattern over the scan region, the second MEMS scanner being located at a fourth location;
detecting a third glint from a third reflection point in the scan region at a third time at the first detector, wherein the third glint includes a first portion of the second scan beam;
determining a third orientation of the second MEMS scanner at the third time;
defining a third plane that includes the first location, the fourth location, and a third scanner-to-glint vector based on the third orientation; and
identifying the corneal center based further on the third plane.

19. The method of claim 18 further comprising:
defining a first plane that includes the first location, the second location, and a first scanner-to-glint vector that is based on the first orientation;
defining a second plane that includes the first location, the third location, and a second scanner-to-glint vector that is based on the second orientation;
identifying a first line of intersection between the first and second planes; and
identifying a corneal center for a cornea of the eye based on the first line of intersection.

20. The method of claim 19 further comprising:
generating a first output signal based on a reflection signal from the scan region that includes at least one of (a) a third portion of the first scan beam and (b) a second portion of the second scan beam;
identifying a pupil center for the eye based on the first output signal; and
defining a gaze vector for the eye based on the corneal center and the pupil center.

21. The method of claim 18 further comprising providing the first and second scan beams such that they are out of phase with each other.

22. The method of claim 18 further comprising alternately providing the first and second scan beams such that only one is provided at a time.

23. The method of claim 16 further comprising applying a refractive correction to the first reflection point.
